(19) United States
(12) Patent Application Publication
(10) Pub. No.: US 2004/0120143 A1
(43) Pub. Date: Jun. 24, 2004

(54) Flashlight with a sound system

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/327,003

(22) Filed: Dec. 24, 2002

(51) Int. Cl. F21L 13/06; F21V 33/00

(52) U.S. Cl. 362/192; 362/202; 362/253

(57) ABSTRACT

A flashlight with a sound system includes a musical set, a generator and a flashlight body. The musical set includes a knob and a musical shaft driven by a knob to broadcast music and also to activate the generator to illuminate an illumination device of the flashlight body simultaneously, without using batteries.

### FIELD OF THE INVENTION

This invention relates to a flashlight, and more particularly, to a flashlight that self-generates power and outputs sound while illumination.

### BACKGROUND OF THE INVENTION

A flashlight is always useful and essential equipment in each family for emergency use. However, a conventional flashlight requires batteries to operate, which consumes batteries fast and may not function without batteries. This design requires a user to purchase batteries and the disposal of used batteries may cause environment pollution. Further, the traditional flashlight only has single function, illumination, when in emergency status, such as an earthquake, people are buried under a collapse building, light is impossible to penetrate through ashes, thus the flashlight is useless to the owner without sound.

The inventor has derived the present invention to improve the above-mentioned shortcomings

### SUMMARY OF THE INVENTION

It is the primary object of the present invention to provide a flashlight with a sound system, which saves energy and prevents environmental pollution.

It is another object of the present invention to provide a flashlight with a sound system, which has multiple functions both in illumination and sound.

### BRIEF DESCRIPTION OF THE DRAWINGS

FIG. 1 is an exploded view of a flashlight of the present invention; and

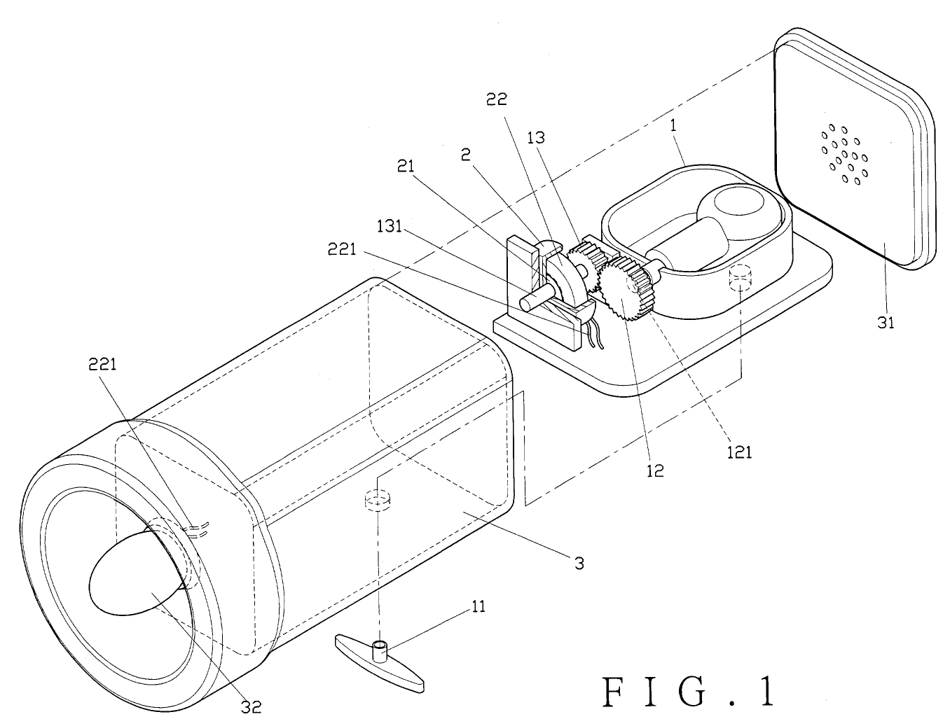

FIG. 2 is a sectional view of the present invention.

### DETAIL DESCRIPTION OF THE PREFERRED EMBODIMENT

A flashlight with a sounding system of the present invention comprises a musical set 1, a generator 2 and a flashlight body 3.

The musical set 1 comprises a knob 11, a driving gear 12, a musical shaft 121, and a driven gear 13. The knob 11 is through a spiral spring, a gear box to control the musical shaft 121 to spin and cause the musical set 1 to broadcast music sound. (The spiral spring, the gear box and the musical shaft are prior arts, not be discussed hereinafter). The musical shaft 121 is secured with the driving gear 12. The driving gear 12 meshes with the driven gear 13 having a shaft 131.

The generator 2 is formed with a magnet 21 and a coil 22. The magnet 21 is secured to the shaft 131 of the driven gear 13. The magnet 21 rotates with respect to the coil 22 to produce electric power. The coil 22 comprises a power cord 221 to lead electric power outward.

The flashlight body 3 has a hollow body to receive the musical set 1 and the generator 2 therein, and is sealed with a cover 31. The flashlight body 3 comprises an illumination device 32 connected with the power cord 221.

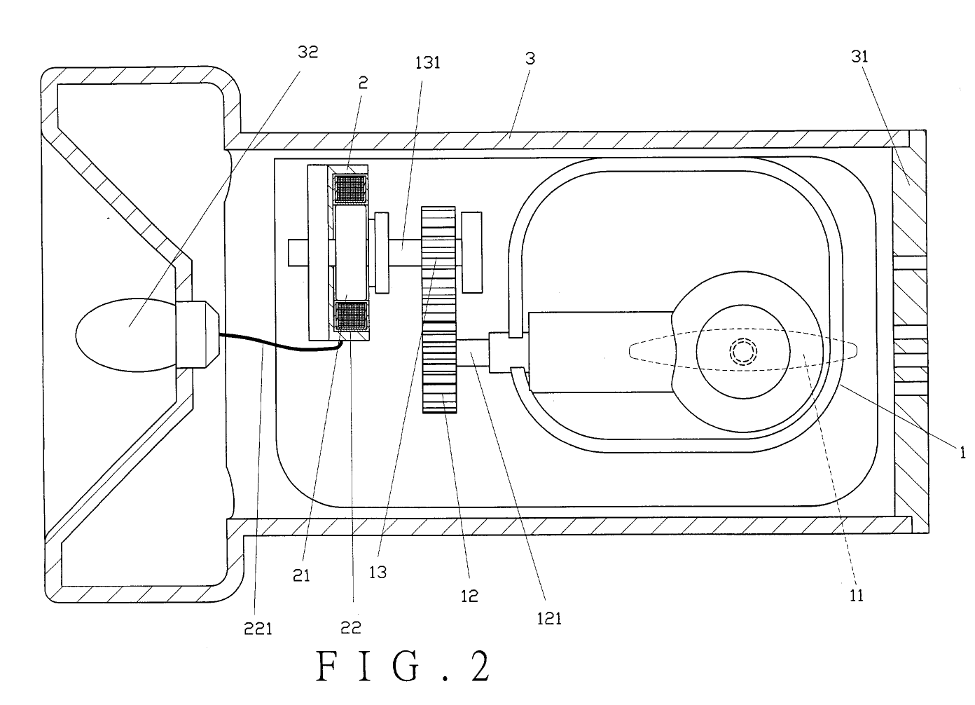

To operate the present invention, as shown in FIG. 2, the knob 11 is turned to activate the musical set 1 to broadcast music. The musical set 1 activates the musical shaft 121 of the driving gear 12 to turn, and the driving gear 12 meshes the driven gear 13 to turn. The shaft 131 of the driven gear 13 activates the magnet 21 to rotate with respect to the coil 22 to produce electric power outputted through the power cord 221 to illuminate the illumination device 32. This eliminates battery requirement.

I claim:

1. A flashlight with a sound system comprising a musical set, a generator and a flashlight body, wherein said musical set comprising a knob and a musical shaft, said knob controlling said musical shaft to turn and to produce sound, said generator comprising a magnet and a coil, said coil rotating with respect to said magnet and being able to produce electric power, said flashlight body comprising an illumination device, and the improvement comprising:
said musical set comprising a driving gear and a driven gear, said driving gear being secured with said musical shaft, and said driving gear meshing with said driven gear, said musical set and said generator being secured in said flashlight body, and said magnet being coaxial with said driven gear, and said coil having a power cord connected with said illumination device of said flashlight body.
